(19) United States
(12) Patent Application Publication
(10) Pub. No.: US 2025/0329496 A1
(43) Pub. Date: Oct. 23, 2025

(54) MULTILAYER CERAMIC CAPACITOR

(71) Applicant: Murata Manufacturing Co., Ltd., Nagaokakyo-shi (JP)

(72) Inventor: Akira ISHIZUKA, Nagaokakyo-shi (JP)

(21) Appl. No.: 19/251,871

(22) Filed: Jun. 27, 2025

Related U.S. Application Data
(63) Continuation of application No. PCT/JP2023/041748, filed on Nov. 21, 2023.

(30) Foreign Application Priority Data
Dec. 28, 2022 (JP) 2022-212597

(51) Int. Cl. H01G 4/012; H01G 4/232; H01G 4/30

(52) U.S. Cl. CPC H01G 4/012; H01G 4/232; H01G 4/30

(57) ABSTRACT

A multilayer ceramic capacitor includes a multilayer body including an inner layer portion including dielectric layers and internal electrode layers, first and second main surfaces opposed to each other in a stacking direction, and external electrodes on two end surfaces or two lateral surfaces and connected to the internal electrode layers. A distance between a first lateral surface side end of an internal electrode layer closest to the first main surface and the first lateral surface side end of an internal electrode layer closest to the second main surface is longer than a distance between a second lateral surface side end of the internal electrode layer closest to the first main surface and the second lateral surface side end of the internal electrode layer which is closest to the second main surface.

### CROSS REFERENCE TO RELATED APPLICATIONS

This application claims the benefit of priority to Japanese Patent Application No. 2022-212597 filed on Dec. 28, 2022 and is a Continuation Application of PCT Application No. PCT/JP2023/041748 filed on Nov. 21, 2023. The entire contents of each application are hereby incorporated herein by reference.

### BACKGROUND OF THE INVENTION

### 1. Field of the Invention

The present invention relates to multilayer ceramic capacitors.

### 2. Description of the Related Art

In recent years, development has been advancing to further reduce the size and the weight of multilayer ceramic capacitors that are widely used in electronic devices such as mobile phones, accompanying the reduction in size of electronic devices (for example, refer to Japanese Unexamined Patent Application, Publication No. H8-306580).

On the other hand, when mounting such multilayer ceramic capacitors, the external electrodes are attached to solder paste applied on a land of a substrate, and the electronic components are mounted on the substrate by heating the entire substrate on which electronic components such as multilayer ceramic capacitors are fixed to melt the solder paste, and then allowed to harden.

At this time, if the balance of solder melting on the land is disrupted and a fillet is formed with solder flowing around and/or under one of the external electrodes of the multilayer ceramic capacitor, a phenomenon known as the tombstone phenomenon occurs, in which chips such as multilayer ceramic capacitors stand up due to the surface tension during solder melting.

In particular, as multilayer ceramic capacitors become smaller and their weight decreases, the tombstone phenomenon is likely to occur more easily.

Therefore, there is a demand for multilayer ceramic capacitors each with a configuration that is less likely to cause the tombstone phenomenon, to reliably mount multilayer ceramic capacitors with reduced sizes.

### SUMMARY OF THE INVENTION

Example embodiments of the present invention provide multilayer ceramic capacitors each with high mounting reliability that are each able to reliably reduce or prevent the occurrence of the tombstone phenomenon compared to conventional multilayer ceramic capacitors.

The inventor of example embodiments of the present invention has discovered that, by making the distance T1 between the end portion adjacent to the first lateral surface of the internal electrode layer positioned closest to the first main surface and the end portion adjacent to the first lateral surface of the internal electrode layer positioned closest to the second main surface longer than the distance T2 between the end portion adjacent to the second lateral surface of the internal electrode layer positioned closest to the first main surface and the end portion adjacent to the second lateral surface of the internal electrode layer positioned closest to the second main surface in the inner layer portion where a plurality of dielectric layers and a plurality of internal electrode layers are alternately laminated, the center of gravity of the multilayer ceramic capacitor can be shifted toward the first lateral surface, and by mounting with the first lateral surface facing the substrate, the occurrence of the tombstone phenomenon can be reduced or prevented.

An example embodiment of the present invention provides a multilayer ceramic capacitor which includes a multilayer body including an inner layer portion in which a plurality of dielectric layers and a plurality of internal electrode layers are alternately laminated, a first main surface and a second main surface opposed to each other in a lamination direction, a first end surface and a second end surface opposed to each other in a length direction intersecting with the lamination direction, and a first lateral surface and a second lateral surface opposed to each other in a width direction intersecting with the lamination direction and the length direction, and a plurality of external electrodes each provided on one of the first and second end surfaces or the first and second lateral surfaces of the multilayer body and each connected to the plurality of internal electrode layers, in which, when viewing a cross section obtained by cutting the multilayer body along a plane perpendicular or substantially perpendicular to the length direction at a position where the external electrodes are not provided, the multilayer ceramic capacitor includes a portion in which a distance T1 between an end portion adjacent to the first lateral surface of an internal electrode layer positioned closest to the first main surface and an end portion adjacent to the first lateral surface of an internal electrode layer positioned closest to the second main surface is longer than a distance T2 between an end portion adjacent to the second lateral surface of the internal electrode layer positioned closest to the first main surface and an end portion adjacent to the second lateral surface of the internal electrode layer positioned closest to the second main surface.

According to example embodiments of the present invention, it is possible to reduce or prevent the occurrence of the tombstone phenomenon during mounting, and to provide multilayer ceramic capacitors each with high mounting reliability.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic perspective view of a multilayer ceramic capacitor 1 according to a first example embodiment of the present invention.

FIG. 2 is a cross-sectional view taken along the line II-II shown in FIG. 1 of the multilayer ceramic capacitor 1 according to the first example embodiment of the present invention.

FIG. 3 is a cross-sectional view taken along the line III-III shown in FIG. 1 of the multilayer ceramic capacitor 1 according to the first example embodiment of the present invention.

FIG. 4 is an exploded perspective view for explaining the lamination state of an inner layer portion 11 of the multilayer ceramic capacitor 1 according to the first example embodiment of the present invention.

FIG. 5 is a flowchart for explaining a manufacturing method of the multilayer ceramic capacitor 1 according to the first example embodiment of the present invention.

FIG. 6 is a perspective view of a material sheet 203 on which internal electrode layer patterns 103 functioning as internal electrode layers 15 of the multilayer ceramic capacitor 1 according to the first example embodiment of the present invention are printed on the surface of a ceramic green sheet 101.

FIG. 7 is a perspective view showing a state where a ceramic paste 102 is placed on the material sheet 203.

FIG. 8 is a partial cross-sectional view of FIG. 7.

FIG. 9 is a diagram explaining the lamination state of the material sheet 203.

FIG. 10 is a diagram showing the mounting state of the multilayer ceramic capacitor 1 according to the first example embodiment of the present invention.

FIG. 11 is a schematic perspective view of a multilayer ceramic capacitor 300 according to a second example embodiment of the present invention.

FIG. 12 is an exploded perspective view explaining the state of internal electrode layers 15 in the inner layer portion 11 of the multilayer ceramic capacitor 300 according to the second example embodiment of the present invention.

FIG. 13 is an exploded perspective view explaining the arrangement of ceramic pastes 102A and 102B in the inner layer portion 11 of the multilayer ceramic capacitor 300 according to the second example embodiment of the present invention.

### DETAILED DESCRIPTION OF THE EXAMPLE EMBODIMENTS

Example embodiments of the present invention will be described in detail below with reference to the drawings.

Hereinafter, multilayer ceramic capacitors according to example embodiments of the present invention will be described with a two-terminal ceramic capacitor as a first example embodiment and a three-terminal multilayer ceramic capacitor as a second example embodiment, for example.

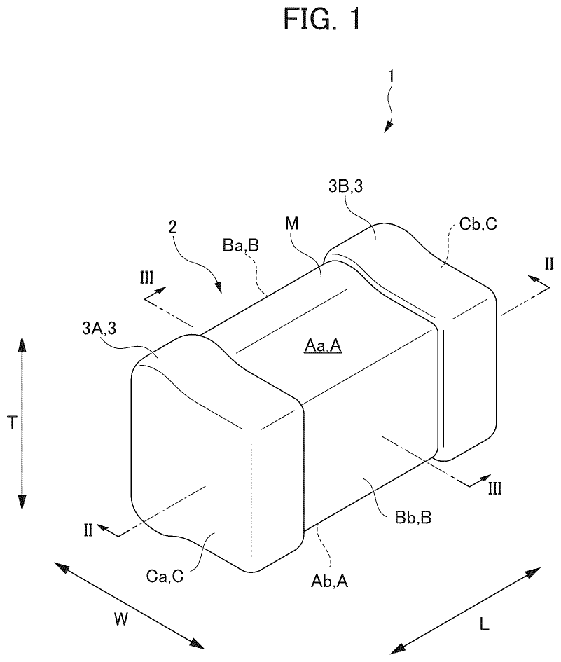

FIG. 1 is a schematic perspective view of the multilayer ceramic capacitor 1 according to a first example embodiment of the present invention.

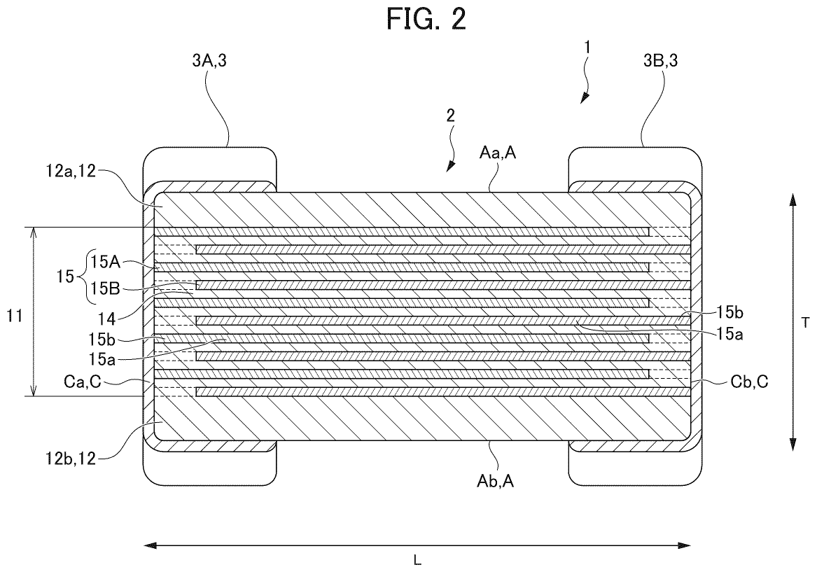

FIG. 2 is a cross-sectional view taken along the line II-II shown in FIG. 1 of the multilayer ceramic capacitor 1 according to the first example embodiment.

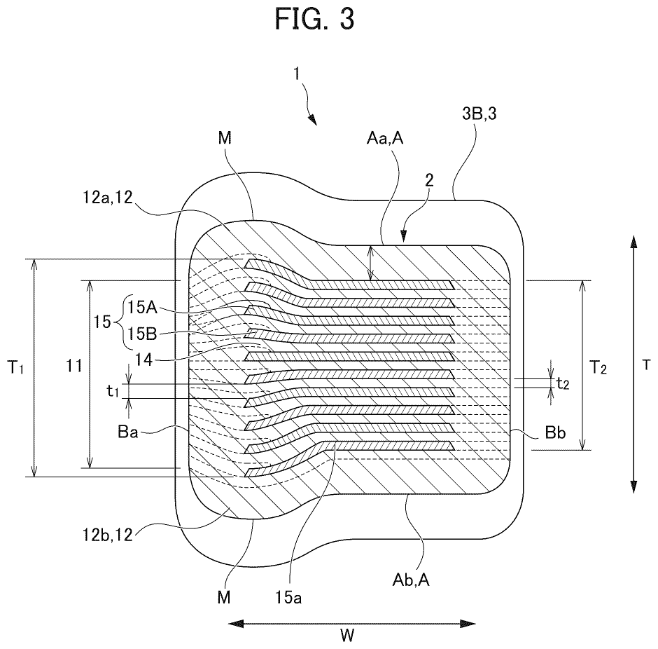

FIG. 3 is a cross-sectional view taken along the line III-III shown in FIG. 1 of the multilayer ceramic capacitor 1 according to the first example embodiment.

Example embodiments exemplarily illustrate example embodiments of the present invention, and the present invention is not limited to the example embodiments.

It is also possible to combine and include the features described in different example embodiments, and are also included in the present invention.

The drawings are intended to aid in understanding the specification and may be schematically drawn in some cases, and the ratios of the dimensions of components or between components shown in the drawings may not match the ratios of dimensions described in the specification.

Also, components described in the specification may be omitted in the drawings, or the number of components may be omitted in the drawings.

### Multilayer Ceramic Capacitor 1

The multilayer ceramic capacitor 1 is a two-terminal multilayer ceramic capacitor (first example embodiment).

The multilayer ceramic capacitor 1 includes a multilayer body 2 and a pair of end surface external electrodes 3 provided at both ends of the multilayer body 2.

The multilayer body 2 includes an inner layer portion 11 including multiple sets of dielectric layers 14 and internal electrode layers 15, and outer layer portions 12.

The dimensions of the multilayer ceramic capacitor 1 are not particularly limited, but, for example, it is preferable that the dimension in the length direction L is about 0.6 mm or more and about 3.2 mm or less, the dimension in the width direction W is about 0.3 mm or more and about 2.5 mm or less, and the dimension in the lamination direction T is about 0.3 mm or more and about 2.5 mm or less.

In the following description, as terms indicating the orientation of the multilayer ceramic capacitor 1, the direction in which the dielectric layers 14 and the internal electrode layers 15 are laminated in the multilayer ceramic capacitor 1 is defined as the lamination direction T.

The direction that intersects with the lamination direction T and in which the pair of end surface external electrodes 3 are provided in the multilayer ceramic capacitor 1 is defined as the length direction L.

The direction that intersects with both the length direction L and the lamination direction T is defined as the width direction W.

In the example embodiments, the lamination direction T, the length direction L, and the width direction W are orthogonal or substantially orthogonal to each other.

Also, FIG. 2 is an LT cross-section passing through the length direction L and the lamination direction T, obtained by cutting the multilayer ceramic capacitor 1 along a plane perpendicular or substantially perpendicular to the width direction W, and FIG. 3 is a WT cross-section passing through the width direction W and the lamination direction T, obtained by cutting the multilayer ceramic capacitor 1 along a plane perpendicular or substantially perpendicular to the length direction L.

Furthermore, in the following description, among the six outer surfaces of the multilayer body 2, the pair of outer surfaces opposed to each other in the lamination direction T are defined as a first main surface Aa and a second main surface Ab, the pair of outer surfaces opposed to each other in the width direction W are defined as a first lateral surface Ba and a second lateral surface Bb, and the pair of outer surfaces opposed to each other in the length direction L are defined as a first end surface Ca and a second end surface Cb.

When it is not necessary to particularly distinguish between the first main surface Aa and the second main surface Ab, they are collectively referred to as the main surface A.

When it is not necessary to particularly distinguish between the first lateral surface Ba and the second lateral surface Bb, they are collectively referred to as the lateral surface B.

When it is not necessary to particularly distinguish between the first end surface Ca and the second end surface Cb, they are collectively referred to as the end surface C.

### Multilayer Body 2

The multilayer body 2 includes an inner layer portion 11 and the outer layer portions 12 provided on both sides of the inner layer portion 11 in the lamination direction T.

The dimensions of the multilayer body 2 are not particularly limited, but, for example, it is preferable that the dimension in the length direction L is about 0.6 mm or more and about 3.2 mm or less, the dimension in the width direction W is about 0.3 mm or more and about 2.5 mm or less, and the dimension in the lamination direction T is about 0.3 mm or more and about 2.5 mm or less.

### Inner Layer Portion 11

The inner layer portion 11 includes the multiple sets of dielectric layers 14 and internal electrode layers 15 alternately laminated along the lamination direction T.

### Internal Electrode Layer 15

The internal electrode layers 15 include a plurality of first internal electrode layers 15A and a plurality of second internal electrode layers 15B.

The first internal electrode layers 15A and the second internal electrode layers 15B are alternately provided.

When it is not necessary to particularly distinguish between the first internal electrode layers 15A and the second internal electrode layers 15B, they are collectively referred to as the internal electrode layers 15.

The internal electrode layers 15 are preferably made of a metal material such as, for example, Ni, Cu, Ag, Pd, Ag—Pd alloy, Au, etc.

The thickness of each of the internal electrode layers 15 in the lamination direction T is, for example, preferably about 0.25 μm or more and about 0.60 μm or less, and particularly preferably about 0.3 μm or more and about 0.5 μm or less.

The number of internal electrode layers 15 is, for example, preferably 14 or more and 1000 or less.

Each of the internal electrode layers 15 includes a counter portion 15a and an extension portion 15b that extends from the counter portion 15a to the end surface C and is connected to the end surface external electrode 3.

### Dielectric Layer 14

The dielectric layers 14 are each made of, for example, a ceramic material.

As the ceramic material, for example, a dielectric ceramic with BaTiO₃ as a main component is used.

Also, as the ceramic material, at least one sub-component such as, for example, Mn compound, Fe compound, Cr compound, Co compound, Ni compound, etc. may be added to these main components.

The thickness of each of the dielectric layers 14 in the lamination direction T is, for example, preferably about 0.3 μm or more and about 1.5 μm or less, and particularly preferably about 0.5 μm or more and about 1.0 μm.

The number of dielectric layers 14, including the upper outer layer portion 12a and the lower outer layer portion 12b, is, for example, preferably 14 or more and 1000 or less.

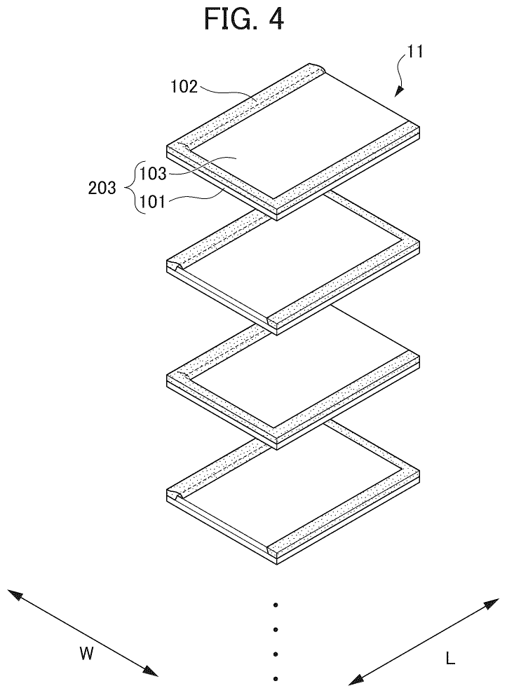

FIG. 4 is an exploded perspective view explaining the lamination state of the inner layer portion 11.

As will be described in detail later, during the manufacture of the multilayer ceramic capacitor 1, a ceramic paste 102 is printed in regions where no internal electrode layer pattern 103 is arranged on a material sheet 203 on which the internal electrode layer pattern 103 defining and functioning as the internal electrode layer 15 is printed on a ceramic green sheet 101 defining and functioning as the dielectric layer 14.

Also, the ceramic paste 102 overlaps with one edge of each of the internal electrode layers 15 adjacent to the first lateral surface Ba with a certain width.

The inner layer portion 11 is formed by laminating the material sheet 203 on which the internal electrode layer pattern 103 and the ceramic paste 102 are printed on such a ceramic green sheet 101.

Since the ceramic paste 102 overlaps with one edge of each of the internal electrode layers 15 adjacent to the first lateral surface Ba with a certain width, as shown in FIG. 3, the end portion of the internal electrode layers 15 adjacent to the first lateral surface Ba has a wider interval in the lamination direction T.

Further, in the multilayer body 2 in which the plurality of internal electrode layers 15 are laminated, the distance T1 between the end portion adjacent to the first lateral surface Ba of the uppermost internal electrode layer 15 positioned closest to the first main surface Aa and the end portion adjacent to the first lateral surface Ba of the lowermost internal electrode layer 15 positioned closest to the second main surface Ab is longer than the distance T2 between the end portion adjacent to the second lateral surface Bb of the uppermost internal electrode layer 15 positioned closest to the first main surface Aa and the end portion adjacent to the second lateral surface Bb of the lowermost internal electrode layer 15 positioned closest to the second main surface Ab.

Here, the measurement of the distance T1 between the end portion adjacent to the first lateral surface Ba of the uppermost internal electrode layer 15 positioned closest to the first main surface Aa and the end portion adjacent to the first lateral surface Ba of the lowermost internal electrode layer 15 positioned closest to the second main surface Ab, and the distance T2 between the end portion adjacent to the second lateral surface Bb of the uppermost internal electrode layer 15 positioned closest to the first main surface Aa and the end portion adjacent to the second lateral surface Bb of the lowermost internal electrode layer 15 positioned closest to the second main surface Ab can be measured using, for example, a scanning electron microscope (SEM) or a metallurgical microscope on a cross-section obtained by cross-sectionally polishing the multilayer ceramic capacitor 1 at an angle perpendicular or substantially perpendicular to the length direction up to a position that is about ½ of the length dimension in the length direction of the multilayer ceramic capacitor 1.

The difference in length between the distance T1 and the distance T2 corresponds to the difference in thickness in the lamination direction T between the first lateral surface Ba and the second lateral surface Bb in the multilayer body 2, and as shown in FIG. 1, a raised portion M is provided along the length direction L adjacent to the surface of the first lateral surface Ba on the first main surface Aa and the second main surface Ab of the multilayer ceramic capacitor 1.

Also, when the internal electrode layers 15 are each divided into a middle region including a middle portion, a first lateral surface-side region located closer to the first lateral surface Ba than the middle region, and a second lateral surface-side region located closer to the second lateral surface Bb than the middle region, it is preferable that the distance t1 in the lamination direction at any position in the first lateral surface-side region, which is the distance between two adjacent internal electrode layers 15, is longer than the distance t2 in the lamination direction at any position in the second lateral surface-side region, which is the distance between two adjacent internal electrode layers 15.

Here, the measurement of the distance t1 in the lamination direction at any position in the first lateral surface-side region and the distance t2 in the lamination direction at any position in the second lateral surface-side region can be measured using, for example, a scanning electron microscope (SEM) or a metallurgical microscope on a cross-section obtained by cross-sectionally polishing the multilayer ceramic capacitor 1 at an angle perpendicular or substantially perpendicular to the length in the length direction, up to a position that is about ½ of the length dimension in the length direction of the multilayer body.

The volume of the multilayer body 2 of the multilayer ceramic capacitor 1 is larger on the first lateral surface Ba than on the second lateral surface Bb, and the weight is greater on the first lateral surface Ba than on the second lateral surface Bb. Therefore, the center of gravity of the multilayer body 2 is located closer to the first lateral surface Ba from the center of the multilayer body 2.

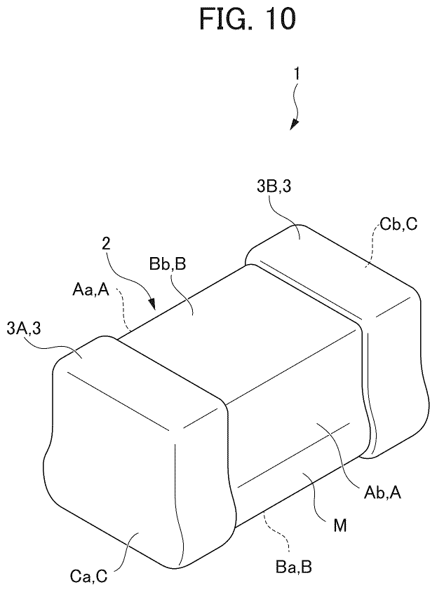

Therefore, as shown in FIG. 10, when the multilayer ceramic capacitor 1 is mounted with the first lateral surface Ba facing the substrate, the center of gravity of the multilayer ceramic capacitor 1 can be brought closer to the substrate with a minimal increase in weight. This makes it possible to effectively reduce or prevent the occurrence of the tombstone phenomenon during mounting.

When mounting, in order to reliably position the first lateral surface Ba facing the substrate, it is preferable that the multilayer body 2 includes an identifier to identify the direction of placement on the first lateral surface Ba and/or the second lateral surface Bb.

Although not particularly limited, examples of the identifier include printing, engraving, or coloring on the second lateral surface Bb.

Also, in order to position the first lateral surface Ba facing the substrate, it is preferable to provide an identifier to identify the direction of placement on the end surface external electrode 3.

Although not particularly limited, examples of the identifier include establishing the shape or length of the surface of the end surface external electrode 3 on the second lateral surface Bb different from the shape of the first lateral surface Ba.

### Outer Layer Portion 12

The outer layer portions 12 include an upper outer layer portion 12a provided on one side of the inner layer portion 11, and a lower outer layer portion 12b provided on the other side of the inner layer portion 11 in the lamination direction T.

When it is not necessary to particularly distinguish between the upper outer layer portion 12a and the lower outer layer portion 12b, they are collectively referred to as the outer layer portion 12.

The outer layer portion 12 is made of the same material as the dielectric layers 14 of the inner layer portion 11.

The thickness of each of the outer layer portions 12 is, for example, about 20 μm or less, and more preferably about 10 μm or less.

The upper outer layer portion 12a and the lower outer layer portion 12b are provided on both sides of the inner layer portion in the lamination direction with a predetermined thickness.

In the example embodiments, they have the same thickness, but this is not limiting, and they may have different thicknesses.

### End Surface External Electrode 3

The end portion of each of the extension portions 15b of the first internal electrode layers 15A is exposed at the first end surface Ca, and is electrically connected to the first end surface external electrode 3A.

The end portion of each of the extension portions 15b of the second internal electrode layers 15B is exposed at the second end surface Cb, and is electrically connected to the second end surface external electrode 3B.

As a result, the configuration between the first end surface external electrode 3A and the second end surface external electrode 3B is such that the plurality of capacitor elements are electrically connected in parallel.

In addition, the end surface external electrode 3 covers not only the end surface C, but also a portion of the main surface A and a portion of the lateral surface B adjacent to the end surface C, and also covers the raised portion M of the multilayer body 2.

The end surface external electrode 3 and the lateral surface external electrode 4 included in a second example embodiment of the present invention described later can both have a configuration including a base electrode layer and a plated layer provided on the base electrode layer.

The base electrode layer includes, for example, at least one of a fired layer, an electrically conductive resin layer, a direct plated layer, etc., as described below.

### Fired Layer

The fired layer is formed by, for example, applying an electrically conductive paste including glass and metal to the multilayer body and firing it, which may be co-fired with the internal electrodes or fired after the internal electrodes are fired.

The temperature for the firing treatment is, for example, preferably about 700° C. to about 900° C.

The glass component includes, for example, at least one of B, Si, Ba, Mg, Al, or Li, etc.

Examples of the metal include at least one of Cu, Ni, Ag, Pd, Ag—Pd alloy, or Au, etc.

The thickness of the fired layer is preferably, for example, about 3 μm or more and about 70 μm or less.

The fired layer may also include a plurality of layers.

### Electrically Conductive Resin Layer

The electrically conductive resin layer is provided on the surface of the fired layer, or provided directly on the surface of the multilayer body.

The electrically conductive resin layer may include a plurality of layers.

As an example of a method for forming the electrically conductive resin layer, an electrically conductive resin paste including a thermosetting resin and a metal component is applied to the fired layer or the multilayer body, and heat treatment is performed at a temperature of, for example, about 250° C. to about 550° C. or higher to thermally cure the resin, thus forming the electrically conductive resin layer.

The atmosphere during the heat treatment is, for example, preferably an N₂ atmosphere.

Also, in order to prevent the scattering of the resin and prevent oxidation of various metal components, it is preferable to keep the oxygen concentration at, for example, about 100 ppm or less.

The thickness of the electrically conductive resin layer at the middle portion of the end surface C is, for example, preferably about 10 μm or more and about 150 μm or less.

As the resin for the electrically conductive resin layer, various known thermosetting resins such as, for example, epoxy resin, phenol resin, urethane resin, silicone resin, polyimide resin, or the like can be used.

Among these, for example, epoxy resins are suitable resins due to their excellent heat resistance, moisture resistance, and adhesion.

The resin included in the electrically conductive resin layer is, for example, preferably included in an amount of about 25 vol % or more and about 65 vol % or less with respect to the total volume of the electrically conductive resin.

The electrically conductive resin layer preferably includes a curing agent together with the thermosetting resin.

As the curing agent, when an epoxy resin is used as the base resin, various known compounds such as, for example, phenol-based, amine-based, acid anhydride-based, or imidazole-based compounds can be used as curing agents for the epoxy resin.

Since the electrically conductive resin layer includes a thermosetting resin, it has more flexibility than, for example, an electrically conductive layer made of a plating film or a fired electrically conductive paste.

Therefore, even when a physical impact or shock due to thermal cycling is applied to the ceramic electronic component, the electrically conductive resin layer defines and functions as a buffer layer, thus preventing cracks in the ceramic electronic component.

As the metal included in the electrically conductive resin layer, for example, Ag, Cu, or alloys thereof can be used.

Also, for example, metal powder with an Ag coating on the surface can be used.

When using metal powder with an Ag coating on the surface, it is preferable to use, for example, Cu or Ni as the metal powder.

Alternatively, a metal powder in which oxidation prevention treatment has been conducted on the Cu can also be used.

The reason for using Ag electrically conductive metal powder as the electrically conductive metal is that Ag has a relatively low specific resistance among metals, making it suitable as an electrode material, and Ag is a noble metal that does not oxidize and has high stability.

The reason for using metal coated with Ag is that it maintains the characteristics of Ag as described above, while making it possible to use a less expensive metal as the base material.

The metal included in the electrically conductive resin layer is, for example, preferably included in an amount of about 35 vol % or more and about 75 vol % or less with respect to the total volume of the electrically conductive resin.

The shape of the metal included in the electrically conductive resin layer is not particularly limited.

The electrically conductive filler may be spherical, flat, or the like.

The average particle size of the metal included in the electrically conductive resin layer is not particularly limited, but can be, for example, about 0.3 μm or more and about 10 μm or less.

The metal included in the electrically conductive resin layer mainly provides electrical conductivity to the electrically conductive resin layer.

Specifically, electrically conductive fillers contact each other to provide an electric conduction path inside the electrically conductive resin layer.

### Plated Layer

A direct plated layer may be provided on the end surface where the internal electrodes of the multilayer body are exposed.

That is, the multilayer ceramic capacitor may include a configuration including a plated layer that is directly electrically connected to the internal electrode layers and surface electrode layers.

In such a case, a direct plated layer may be provided after providing a catalyst on the surface of the multilayer body as a pretreatment.

The plated layer preferably includes, for example, at least one metal of Cu, Ni, Sn, Pb, Au, Ag, Pd, Bi, or Zn, or an alloy including the metal.

For example, when the first internal electrode layers and the second internal electrode layers includes Ni, the direct plated layer preferably includes Cu, which has good bonding properties with Ni.

The thickness per layer of the plated layer is, for example, preferably about 2 μm or more and about 15 μm or less.

The plated layer preferably does not include glass.

The metal content per unit volume of the plated layer is, for example, preferably about 99% by volume or more.

For the plating treatment, either electrolytic plating or electroless plating may be used, but electroless plating has the disadvantage in that pretreatment with a catalyst or the like is necessary to improve the plating deposition rate, which complicates the process.

Therefore, electrolytic plating is normally preferable.

As a plating method, for example, barrel plating is preferable.

In addition, if necessary, an upper plated electrode may be similarly provided on the surface of the lower plated electrode.

When the base electrode layer is a thin film layer, the thin film layer is formed by, for example, a thin film formation method such as sputtering or vapor deposition, and is a layer of about 1 μm or less in which metal particles are deposited.

The plated layer provided on the base electrode layer includes at least one of, for example, Cu, Ni, Ag, Pd, Ag—Pd alloy, Au, etc.

The plated layer may include a plurality of layers.

Preferably, for example, the plated layer includes a two-layer configuration of Ni plating and Sn plating.

The Ni plated layer can reduce or prevent the base electrode layer from being eroded by solder when mounting the ceramic electronic component, and the Sn plated layer can improve the wettability of solder when mounting the ceramic electronic component, which facilitates the mounting.

The thickness per plated layer is, for example, preferably about 2 μm or more and about 15 μm or less.

### Manufacturing Method of Multilayer Ceramic Capacitor 1

Next, an example of a manufacturing method of the multilayer ceramic capacitor 1 according to the present example embodiment will be described.

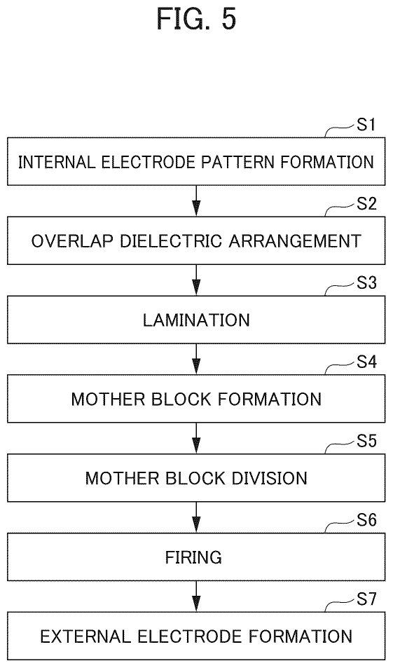

FIG. 5 is a flowchart for explaining the manufacturing method of the multilayer ceramic capacitor 1.

### Internal Electrode Layer Pattern Forming Step S1

First, an internal electrode layer pattern 103 defining and functioning as the internal electrode layer 15 is formed on a ceramic green sheet 101 defining and functioning as the dielectric layer 14 using an electrically conductive paste.

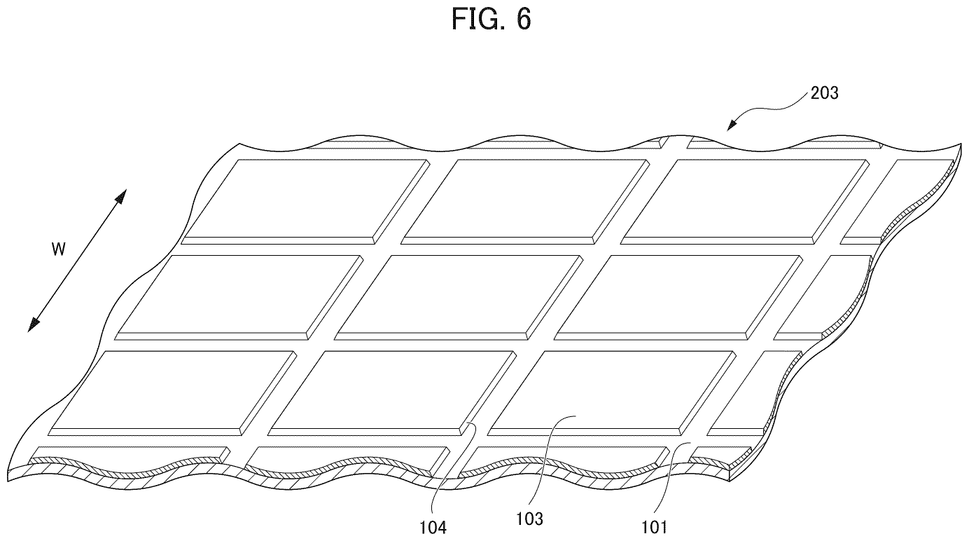

FIG. 6 is a perspective view of a material sheet 203 on which an internal electrode layer pattern 103 defining and functioning as the internal electrode layer 15 is printed on the surface of the ceramic green sheet 101.

### Ceramic Green Sheet 101

The ceramic green sheet 101 is a strip shaped sheet formed by, for example, molding a ceramic slurry including ceramic powder, binder, and solvent into a sheet shape on a carrier film using a die coater, gravure coater, micro-gravure coater, or the like.

### Internal Electrode Layer Pattern 103

The internal electrode layer pattern 103 is formed by, for example, printing such as screen printing, gravure printing, or relief printing.

Here, the internal electrode layer pattern 103 forms step differences 104 on the ceramic green sheet 101 due to its thickness.

In example embodiments of the present invention, each of the step differences 104 is a sloped surface, for example.

### Overlap Dielectric Placement Step S2

Next, the ceramic paste 102 for forming a dielectric layer is placed on the material sheet 203 so as to fill the step differences 104 due to the thickness of the internal electrode layer pattern 103 and to overlap with the internal electrode layer pattern 103, at a certain width, on a side of the internal electrode layer pattern 103 adjacent to the first lateral surface Ba.

Alternatively, the ceramic paste 102 for forming a dielectric layer may be first placed on the material sheet 203 at the outer periphery where the internal electrode layer pattern 103 is to be formed, and then the internal electrode may be placed to overlap with the internal electrode layer pattern 103, at a certain width, on a side of the internal electrode layer pattern 103 adjacent to the first lateral surface Ba.

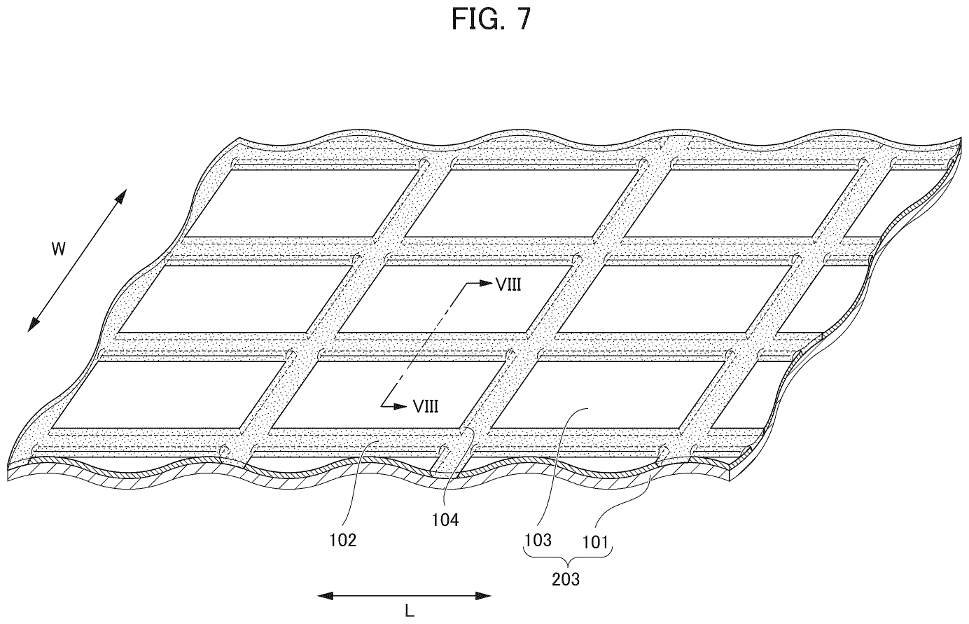

FIG. 7 is a perspective view showing a state where the ceramic paste 102 is placed on the material sheet 203.

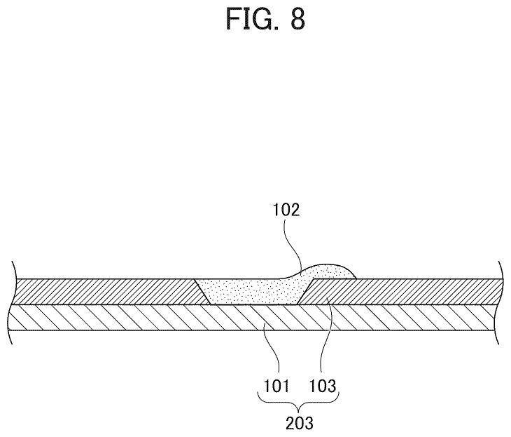

FIG. 8 is a cross-sectional view along the line VIII-VIII in FIG. 7.

The ceramic paste 102 is applied, for example, by printing such as screen printing, gravure printing, relief printing, etc.

The ceramic paste 102 may have a different component ratio from the dielectric material of the ceramic green sheet 101, may have the same component ratio, or may include different components.

The ceramic paste 102 is applied to overlap with the internal electrode layer 15, at a certain width, on a side of the internal electrode layer pattern 103 adjacent to the first lateral surface Ba.

The width of the overlap is, for example, preferably less than about 33% of the width dimension of the internal electrode layer 15, and preferably about 2% or more and about 25% or less.

Also, as shown in FIG. 8, since each of the step differences 104 of the internal electrode layer pattern 103 is a sloped surface, the ceramic paste 102 gradually extends onto the internal electrode layer pattern 103.

Therefore, the upper surface of the ceramic paste 102 is smooth.

The thickness of the ceramic paste 102 is, for example, preferably about 0.4 times or more and about 0.8 times or less the thickness of the ceramic green sheet 101.

### Lamination Step S3

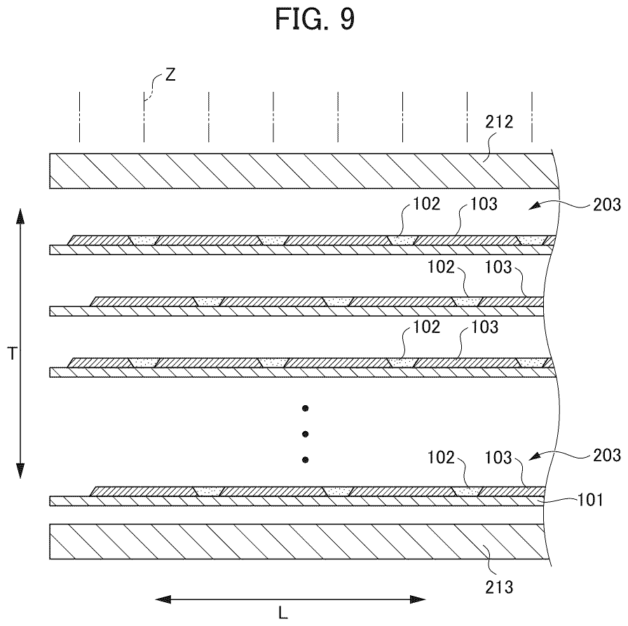

FIG. 9 is a diagram for explaining the lamination state of the material sheet 203.

As shown in FIG. 9, the material sheet 203 is arranged such that adjacent internal electrode layer patterns 103 in the lamination direction T are alternately offset in the length direction L.

Furthermore, an upper outer layer portion ceramic green sheet 212 defining and functioning as the upper outer layer portion 12a is laminated on one side of the plurality of material sheets 203 that are stacked, and a lower outer layer portion ceramic green sheet 213 defining and functioning as the lower outer layer portion 12b is stacked on the other side thereof.

### Mother Block Formation Step S4

Next, the upper outer layer portion ceramic green sheet 212, the plurality of material sheets 203 that are stacked, and the lower outer layer portion ceramic green sheet 213 are thermocompression bonded to form a mother block.

### Mother Block Dividing Step S5

Next, the mother block is cut at the positions Z shown in FIG. 9.

Although only the cutting positions Z in the length direction L are shown, the multilayer body 2 is also cut at predetermined cutting positions in the width direction W extending in a direction perpendicular or substantially perpendicular to the position Z extending in the width direction, and a plurality of rectangular or substantially rectangular multilayer bodies 2 are manufactured.

### Firing Step S6

In the firing step, each of the multilayer chips is subjected to a debinding treatment and a firing treatment to form the base body.

Through the firing treatment, the electrically conductive paste layer and the green sheet for manufacturing the dielectric layer are co-fired to be the internal electrode layers 15 and the dielectric layers 14, respectively.

The conditions for the debinding treatment can be determined according to the type of organic binder included in the green sheet and the electrically conductive paste layer.

It will suffice if the firing treatment is performed at a temperature at which the multilayer chip is sufficiently densified.

The firing temperature is, for example, preferably about 900° C. to about 1400° C., depending on the materials of the dielectric and internal electrode layers.

### External Electrode Formation Step S7

In the external electrode formation step, the end surface external electrodes 3 are formed on the multilayer body 2 to manufacture a multilayer ceramic capacitor 1.

The formation of the end surface external electrodes 3 can be performed using known techniques.

The lateral surface external electrodes 4 included in the second example embodiment described later can also be formed in the same or similar manner as the end surface external electrodes 3.

For example, a base electrode layer, an electrically conductive resin layer, or a direct plated layer is formed on the end surface C where the internal electrode layers 15 of the multilayer body 2 extend toward and are exposed, and further, a plated layer is provided as needed.

In the present example embodiment, for example, a Ni plated layer and a Sn plated layer are formed on the fired layer.

The Ni plated layer and Sn plated layer are sequentially formed by, for example, a barrel plating method.

With such a configuration, it is possible to manufacture multilayer ceramic capacitors.

### Multilayer Ceramic Capacitor 300

A multilayer ceramic capacitor 300 according to a second example embodiment of the present invention is a three-terminal multilayer ceramic capacitor.

Since the dielectric layers, internal electrode layers, external electrodes, etc. of the three-terminal multilayer ceramic capacitor often include components in common with those of the two-terminal multilayer ceramic capacitor according to the first example embodiment, the following description will focus on the configurations that differ from the two-terminal multilayer ceramic capacitor.

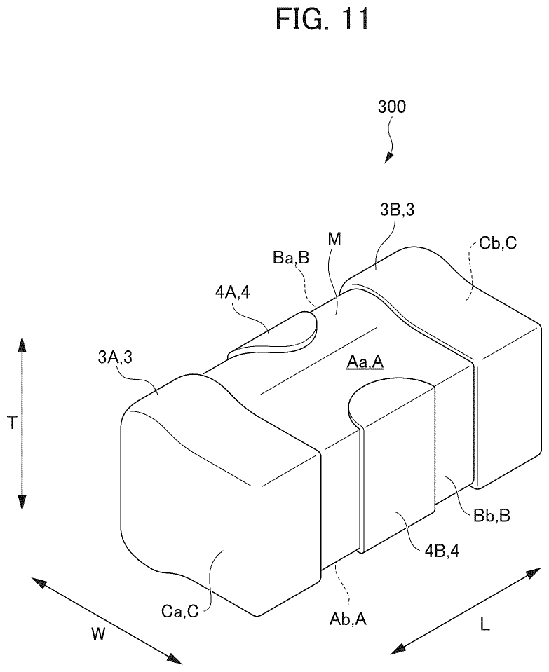

FIGS. 11 to 13 show the shape and configuration of the multilayer ceramic capacitor 300.

FIG. 11 is an external view of the three-terminal multilayer ceramic capacitor 300.

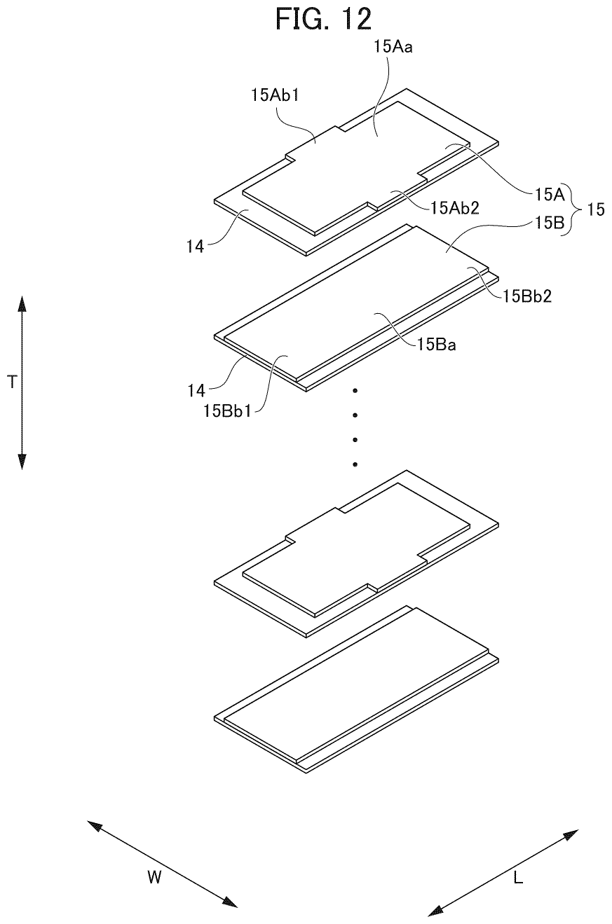

FIG. 12 is an exploded perspective view for explaining the state of an internal electrode layers 15 in the inner layer portion 11 of the multilayer ceramic capacitor 300.

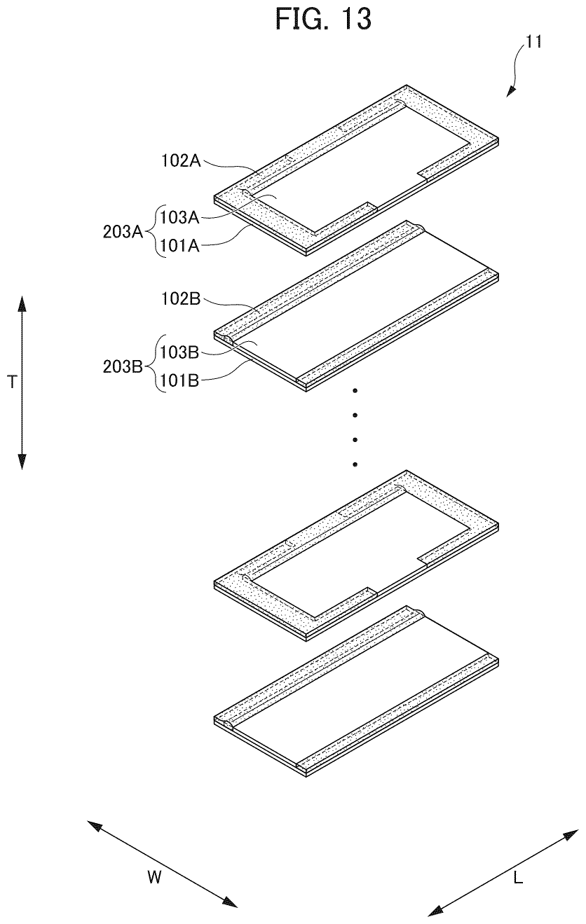

FIG. 13 is an exploded perspective view for explaining the arrangement of ceramic pastes 102A and 102B in the inner layer portion 11 of the multilayer ceramic capacitor 300.

The direction in which the dielectric layers and internal electrode layers are laminated is referred to as the lamination direction T, and the length direction L perpendicular or substantially perpendicular to the lamination direction T, and the width direction W perpendicular or substantially perpendicular to both the lamination direction T and the length direction L are used to describe the configuration of the multilayer ceramic capacitor 300.

In example embodiments, the width direction W, the length direction L, and the lamination direction T are perpendicular or substantially perpendicular to each other, but they are not necessarily perpendicular or substantially perpendicular to each other and may be in an intersecting relationship with each other.

The first end surface external electrode 3A, the second end surface external electrode 3B, and the lateral surface external electrode 4 are provided on the surface of the multilayer body 2.

The first end surface external electrode 3A is provided on the first end surface Ca of the multilayer body 2.

The first end surface external electrode 3A has a cap shape, with its edge portion extending from the first end surface Ca of the multilayer body 2 to the first main surface Aa, the second main surface Ab, the first lateral surface Ba, and the second lateral surface Bb.

The second end surface external electrode 3B is provided on the second end surface Cb of the multilayer body 2.

The second end surface external electrode 3B has a cap shape, with its edge portion extending from the second end surface Cb of the multilayer body 2 to the first main surface Aa, the second main surface Ab, the first lateral surface Ba, and the second lateral surface Bb.

The lateral surface external electrode 4 can be provided on either the left or right lateral surface of the multilayer body 2, but FIG. 11 shows a configuration in which the first lateral surface external electrode 4A and the second lateral surface external electrode 4B are respectively provided on the first lateral surface Ba and the second lateral surface Bb of the multilayer body 2.

The lateral surface external electrode 4 also extends to the first main surface Aa and the second main surface Ab.

FIG. 12 schematically shows the internal electrode layers 15 and the dielectric layers 14 of the multilayer ceramic capacitor 300.

The internal electrode layers 15 each include the first internal electrode layer 15A and the second internal electrode layer 15B.

The first internal electrode layer 15A and the second internal electrode layer 15B are each provided on a corresponding one of the dielectric layers 14.

The first internal electrode layer 15A extends through the interior of the multilayer body 2 in the width direction W to connect with the lateral surface external electrode 4, such that a capacitance is generated with the second internal electrode layer 15B.

In example embodiments, both ends of the first internal electrode layer 15A extend toward the lateral surfaces B of the multilayer body 2 and are connected with the lateral surface external electrode 4. However, an end of the first internal electrode layer 15A may not extend toward the end surfaces C of the multilayer body 2, and thus does not connect with the end surface external electrodes 3.

The first internal electrode layer 15A may have a cross or substantially cross shape as shown in FIG. 12, but is not limited to this shape and can use any shape that connects to the lateral surface external electrode 4 and does not connect to the end surface external electrodes 3.

In the example embodiment shown in FIG. 12, the first internal electrode layer 15A includes a first counter portion 15Aa that is opposed to the second internal electrode layer 15B with the dielectric layer 14 interposed therebetween, a first lateral surface-side extension portion 15Ab1 that extends from the first counter portion 15Aa toward the first lateral surface Ba of the multilayer body 2, and a second lateral surface-side extension portion 15Ab2 that extends from the first counter portion 15Aa toward the second lateral surface Bb of the multilayer body 2. However, either one of the extension portions may be provided, for example, the first lateral surface-side extension portion 15Ab1, to define and function as a three-terminal multilayer ceramic capacitor.

The second internal electrode layer 15B extends through the interior of the multilayer body 2 in the length direction L and connects to the end surface external electrodes 3.

Both ends of the second internal electrode layer 15B extend toward the end surfaces C of the multilayer body and are connected with the end surface external electrodes 3. However, an end of the second internal electrode layer 15B may not extend toward the lateral surfaces B of the multilayer body, and thus does not connect with the lateral surface external electrode 4.

In the example embodiment as shown in FIG. 12, the shape is rectangular or substantially rectangular, but the present invention is not limited thereto.

It will suffice if the second internal electrode layer 15B includes a second counter portion 15Ba that is opposed to the first internal electrode layer 15A with the dielectric layer 14 interposed therebetween, a first extension portion 15Bb1 that extends from the second counter portion 15Ba and extends toward either of two lateral surfaces B or two end surfaces C of the multilayer body 2 at a position different from the first lateral surface-side extension portion 15Ab1 when the multilayer body 2 is viewed in a plan view from the lamination direction T, and a second extension portion 15Bb2 that extends from the second counter portion 15Ba and extends toward either of two lateral surfaces B or two end surfaces C of the multilayer body 2 at a position different from the first lateral surface-side extension portion 15Ab1, the second lateral surface-side extension portion 15Ab2, and the first extension portion 15Bb1 when the multilayer body 2 is viewed in a plan view from the lamination direction T.

The external electrodes may be arranged according to the positions of the first extension portion 15Bb1 and the second extension portion 15Bb2.

The multilayer ceramic capacitor 300 in which the first internal electrode layers 15A are connected to the lateral surface external electrode 4 and the second internal electrode layers 15B are connected to the first end surface external electrode 3A and the second end surface external electrode 3B can be used as a three-terminal capacitor.

That is, the multilayer ceramic capacitor 300 can be used as a three-terminal capacitor by interrupting a power line or a signal line in a circuit, connecting the first end surface external electrode 3A to one of the interrupted portions, connecting the second end surface external electrode 3B to the other of the interrupted portions, and connecting the lateral surface external electrode 4 to ground.

In this case, the second internal electrode layer 15B defines and functions as a through electrode, and the first internal electrode layer 15A defines and functions as a ground electrode.

FIG. 13 schematically shows the areas of ceramic pastes 102A and 102B applied during the manufacturing in the inner layer portion 11 of the multilayer ceramic capacitor 300.

During the manufacturing of the multilayer ceramic capacitor 300, the ceramic paste 102A is printed on regions of a material sheet 203A where an internal electrode layer pattern 103A defining and functioning as the first internal electrode layer 15A is not arranged on a ceramic green sheet 101A defining and functioning as the dielectric layer 14.

Also, the ceramic paste 102A covers the first lateral surface-side extension portion 15Ab1 extending from the first counter portion 15Aa of the first internal electrode layer 15A toward the first lateral surface external electrode 4A adjacent to the first lateral surface Ba.

Additionally, the ceramic paste 102A covers the internal electrode layer pattern 103A at a position corresponding to one side of the first counter portion 15Aa of the first internal electrode layer 15A adjacent to the first lateral surface Ba with a certain width.

Similarly, the ceramic paste 102B is printed on regions of a material sheet 203B where an internal electrode layer pattern 103B defining and functioning as the second internal electrode layer 15B is not arranged on a ceramic green sheet 101B defining and functioning as the dielectric layer 14.

Also, the ceramic paste 102B covers the internal electrode layer pattern 103B at a position corresponding to one side of the second internal electrode layer 15B adjacent to the first lateral surface Ba with a certain width.

Since the ceramic pastes 102A and 102B each overlap the one side of the internal electrode layers 15 adjacent to the first lateral surface Ba with a certain width, the intervals between the ends of the internal electrode layers 15 adjacent to the first lateral surface Ba are wider in the lamination direction T.

Thus, in such a multilayer body 2 in which multiple such internal electrode layers 15 are laminated, when viewing a cross-section obtained by cutting the multilayer body 2 along a plane perpendicular or substantially perpendicular to the length direction L at a position where the lateral surface external electrode 4 is not provided, as shown in the cross-sectional view in FIG. 3, the distance T1 between the end of the uppermost internal electrode layer 15 adjacent to the first lateral surface Ba and the end of the lowermost internal electrode layer 15 adjacent to the first lateral surface Ba is longer than the distance T2 between the end of the uppermost internal electrode layer 15 adjacent to the second lateral surface Bb and the end of the lowermost internal electrode layer 15 adjacent to the second lateral surface Bb.

The volume of the multilayer body 2 of the multilayer ceramic capacitor 300 is larger on the first lateral surface Ba than on the second lateral surface Bb, and the weight is greater on the first lateral surface Ba than on the second lateral surface Bb. Therefore, the center of gravity of the multilayer body 2 is located closer to the first lateral surface Ba from the center of the multilayer body 2.

Therefore, when the multilayer ceramic capacitor 300 is mounted with the first lateral surface Ba facing the substrate, the center of gravity of the multilayer ceramic capacitor 300 can be brought closer to the substrate with a minimal increase in weight. This makes it possible to effectively reduce or prevent the occurrence of the tombstone phenomenon during mounting.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including an inner layer portion including a plurality of dielectric layers and a plurality of internal electrode layers laminated, a first main surface and a second main surface opposed to each other in a lamination direction, a first end surface and a second end surface opposed to each other in a length direction intersecting with the lamination direction, and a first lateral surface and a second lateral surface opposed to each other in a width direction intersecting with the lamination direction and the length direction; and
a plurality of external electrodes each on one of the first and second end surfaces or the first and second lateral surfaces of the multilayer body and each connected to the plurality of internal electrode layers; wherein
when viewing a cross section obtained by cutting the multilayer body along a plane perpendicular or substantially perpendicular to the length direction at a position where the external electrodes are not provided, the multilayer ceramic capacitor includes a portion in which a distance T1 between an end portion adjacent to the first lateral surface of an internal electrode layer positioned closest to the first main surface and an end portion adjacent to the first lateral surface of an internal electrode layer positioned closest to the second main surface is longer than a distance T2 between an end portion adjacent to the second lateral surface of the internal electrode layer positioned closest to the first main surface and an end portion adjacent to the second lateral surface of the internal electrode layer positioned closest to the second main surface.

2. The multilayer ceramic capacitor according to claim 1, wherein, when the plurality of internal electrode layers are each divided into a middle region including a middle portion, a first lateral surface-side region located closer to the first lateral surface than the middle region, and a second lateral surface-side region located closer to the second lateral surface than the middle region, the multilayer ceramic capacitor includes a portion in which a distance t1 in the lamination direction in the first lateral surface-side region, which is a distance between two adjacent internal electrode layers, is longer than a distance t2 in the lamination direction in the second lateral surface-side region, which is a distance between two adjacent internal electrode layers.

3. The multilayer ceramic capacitor according to claim 1, further comprising an identifier to identify a direction of placement on at least one of the first lateral surface or the second lateral surface of the multilayer body.

4. The multilayer ceramic capacitor according to claim 1, further comprising an identifier to identify a direction of placement on the plurality of external electrodes.

5. The multilayer ceramic capacitor according to claim 1, wherein
the plurality of internal electrode layers include a plurality of first internal electrode layers extending toward the first end surface and a plurality of second internal electrode layers extending toward the second end surface; and
the plurality of external electrodes are respectively provided on the first end surface and the second end surface.

6. The multilayer ceramic capacitor according to claim 1, wherein
the plurality of internal electrode layers include a plurality of first internal electrode layers and a plurality of second internal electrode layers;
the plurality of first internal electrode layers each include a first counter portion opposed to a corresponding one of the plurality of second internal electrode layers with a corresponding one of the plurality of dielectric layers interposed therebetween, and a first lateral surface-side extension portion extending from the first counter portion toward the first lateral surface of the multilayer body;
the plurality of second internal electrode layers each include a second counter portion opposed to a corresponding one of the plurality of first internal electrode layers with a corresponding one of the plurality of dielectric layers interposed therebetween, a first extension portion extending from the second counter portion toward one of the first and second lateral surfaces or the first and second end surfaces of the multilayer body at a position different from the first lateral surface-side extension portion when the multilayer body is viewed in a plan view from the lamination direction, and a second extension portion extending from the second counter portion toward one of the first and second lateral surfaces or the first and second end surfaces of the multilayer body at a position different from the first lateral surface-side extension portion and the first extension portion when the multilayer body is viewed in a plan view from the lamination direction; and
the plurality of external electrodes include a first lateral surface-side external electrode connected to the first lateral surface-side extension portion, a first external electrode connected to the first extension portion, and a second external electrode connected to the second extension portion.

7. A multilayer ceramic capacitor comprising:
a multilayer body including an inner layer portion including a plurality of dielectric layers and a plurality of internal electrode layers laminated, a first main surface and a second main surface opposed to each other in a lamination direction, a first end surface and a second end surface opposed to each other in a length direction intersecting with the lamination direction, and a first lateral surface and a second lateral surface opposed to each other in a width direction intersecting with the lamination direction and the length direction; and
a plurality of external electrodes each on one of the first and second end surfaces or the first and second lateral surfaces of the multilayer body and each connected to the plurality of internal electrode layers; wherein
when viewing a cross section obtained by cutting the multilayer body along a plane perpendicular or substantially perpendicular to the length direction at a position where the external electrodes are not provided, and when the plurality of internal electrode layers are each divided into a middle region including a middle portion, a first lateral surface-side region located closer to the first lateral surface than the middle region, and a second lateral surface-side region located closer to the second lateral surface than the middle region, the multilayer ceramic capacitor includes a portion in which a distance t1 in the lamination direction in the first lateral surface-side region, which is a distance between two adjacent internal electrode layers, is longer than a distance t2 in the lamination direction in the second lateral surface-side region, which is a distance between two adjacent internal electrode layers.

8. The multilayer ceramic capacitor according to claim 7, further comprising an identifier to identify a direction of placement on at least one of the first lateral surface or the second lateral surface of the multilayer body.

9. The multilayer ceramic capacitor according to claim 7, further comprising an identifier to identify a direction of placement on the plurality of external electrodes.

10. The multilayer ceramic capacitor according to claim 7, wherein
the plurality of internal electrode layers include a plurality of first internal electrode layers extending toward the first end surface and a plurality of second internal electrode layers extending toward the second end surface; and
the plurality of external electrodes are respectively provided on the first end surface and the second end surface.

11. The multilayer ceramic capacitor according to claim 7, wherein
the plurality of internal electrode layers include a plurality of first internal electrode layers and a plurality of second internal electrode layers;
the plurality of first internal electrode layers each include a first counter portion opposed to a corresponding one of the plurality of second internal electrode layers with a corresponding one of the plurality of dielectric layers interposed therebetween, and a first lateral surface-side extension portion extending from the first counter portion toward the first lateral surface of the multilayer body;
the plurality of second internal electrode layers each include a second counter portion opposed to a corresponding one of the plurality of first internal electrode layers with a corresponding one of the plurality of dielectric layers interposed therebetween, a first extension portion extending from the second counter portion toward one of the first and second lateral surfaces or the first and second end surfaces of the multilayer body at a position different from the first lateral surface-side extension portion when the multilayer body is viewed in a plan view from the lamination direction, and a second extension portion extending from the second counter portion toward one of the first and second lateral surfaces or the first and second end surfaces of the multilayer body at a position different from the first lateral surface-side extension portion and the first extension portion when the multilayer body is viewed in a plan view from the lamination direction; and
the plurality of external electrodes include a first lateral surface-side external electrode connected to the first lateral surface-side extension portion, a first external electrode connected to the first extension portion, and a second external electrode connected to the second extension portion.
